(19) United States
(12) Patent Application Publication
(10) Pub. No.: US 2025/0294486 A1
(43) Pub. Date: Sep. 18, 2025

(54) METHOD, DEVICE AND COMPUTER READABLE MEDIUM FOR COMMUNICATIONS

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 18/860,206

(22) PCT Filed: Apr. 26, 2022
(86) PCT No.: PCT/CN2022/089401

§ 371 Date: Oct. 25, 2024

(51) Int. Cl. H04W 56/00; H04B 7/06; H04L 5/00; H04W 72/21

(52) U.S. Cl. CPC H04W 56/0045; H04B 7/0626; H04L 5/0048; H04W 72/21

(57) ABSTRACT

Embodiments of the present disclosure relate to methods, devices and computer readable media for communications. According to embodiments of the present disclosure, a terminal device receives a first indication indicating a first timing advance (TA) value associated with a first set of Reference Signal (RS) resources. The terminal device receives a second indication indicating a second TA value associated with a second set of RS resources. In response to detecting a beam failure event associated with the first set of RS resources, the terminal device identifies a RS in the second set of RS resources and performs, based on the identified RS, a first uplink transmission with the second TA value.

### FIELD

Embodiments of the present disclosure generally relate to the field of wireless communication, and in particular, to a method, device and computer readable medium for timing adjustment associated with a plurality of network devices.

### BACKGROUND

A wireless communications system may include a number of base stations or network access nodes, such as Transmission Reception Points (TRP), each simultaneously supporting communication for multiple communication devices, which may be also referred as terminal device. In most wireless communication systems, communications between the network access node and the terminal device should meet timing requirements. In other words, these wireless communication systems are timing synchronization systems. However, a terminal device and a network device (for example, TRP) may experience propagation delays for communications between the terminal device and network device (for example, uplink and downlink transmissions). For example, an uplink grant may be transmitted by a network device that grants the terminal device access to resources for uplink transmission. The terminal device may utilize the granted resources but apply a timing advance (TA) for compensating the transmission delay so that the uplink transmissions arrive at the base station at an expected time. The timing advance may be indicated to the terminal device in a TA command sent by the network device (for example, with the uplink grant, via higher layer signaling, etc.). Different terminal devices communicating with the base station may experience different propagation delays and, hence, may need different TA. With the development of communication technology, a terminal device is enabled to access to the communication system via a plurality of network devices. The terminal device, therefore, need to apply different TAs to different links of which each is associated with a different network device.

### SUMMARY

In general, example embodiments of the present disclosure relate to methods, devices and computer readable media for timing adjustment associated with a plurality of network devices.

In a first aspect, there is provided a method implemented at a terminal device. In the method, the terminal device receives a first indication indicating a first timing advance (TA) value associated with a first set of Reference Signal (RS) resources. The terminal device receives a second indication indicating a second TA value associated with a second set of RS resources. In response to detecting a beam failure event associated with the first set of RS resources, the terminal device identifies a RS in the second set of RS resources and performs, based on the identified RS, a first uplink transmission with the second TA value.

In a second aspect, there is provided a method implemented at a terminal device. In the method, the terminal device receives a first indication indicating a first timing advance (TA) value associated with a first set of Reference Signal (RS) resources, the first set of RS resources is applied to a first transmission occasion of two consecutive transmission occasions. The terminal device receives a second indication indicating a second TA value associated with a second set of RS resources, the second set of RS resources is applied to a second transmission occasion of the two consecutive transmission occasions. The terminal device performs, based on an order mapping table indicating an order of the first transmission occasion and the second transmission occasion within the two consecutive transmission occasions, a second uplink transmission in the first transmission occasion with the first TA value and a third uplink transmission in the second transmission occasion with the second TA value.

In a third aspect, there is provided a method implemented at a network device. In the method, the network device transmits, to a terminal device, an indication indicating a first timing advance (TA) value associated with a first set of Reference Signal (RS) resources. In response to detecting a beam failure event associated with the first set of RS resources, the network device performs a reception of a first uplink transmission with a second TA value from the terminal device.

In a fourth aspect, there is provided a method implemented at a network device. In the method, the network device transmits, to a terminal device, an indication indicating a first timing advance (TA) value associated with a first set of Reference Signal (RS) resources. The network device performs, based on an order mapping table indicating an order of the first transmission occasion and a second transmission occasion within the two consecutive transmission occasions, a reception of a second uplink transmission in the first transmission occasion with the first TA value.

In a fifth aspect, there is provided a terminal device. The terminal device comprises a processor and a memory coupled to the processor and storing instructions thereon, the instructions, when executed by the processor, causing the terminal device to perform the method of any of the first aspect and second aspect.

In an sixth aspect, there is provided a network device. The network device comprises a processor and a memory coupled to the processor and storing instructions thereon, the instructions, when executed by the processor, causing the network device to perform the method of any of the third aspect and fourth aspect.

In a ninth aspect, there is provided a computer readable medium having instructions stored thereon, the instructions, when executed on at least one processor, causing the at least one processor to perform the method of any one of the first aspect to the fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process for a timing adjustment associated with a plurality of network devices according to some embodiments of the present disclosure;

FIG. 3 illustrates a timing adjustment for TA value according to some embodiments of the present disclosure;

FIG. 4A and FIG. 4B illustrate a timing adjustment for TA value according to some embodiments of the present disclosure;

FIG. 5 illustrates a restriction on a plurality of TA values according to some embodiments of the present disclosure;

FIG. 6A and FIG. 6B illustrate an example mapping order of transmission occasions according to some embodiments of the present disclosure;

FIG. 7 illustrates a flowchart of an example method implemented at a terminal device in accordance with some embodiments of the present disclosure;

FIG. 8 illustrates a flowchart of an example method implemented at a terminal device in accordance with some embodiments of the present disclosure;

FIG. 9 illustrates a flowchart of an example method implemented at a network device in accordance with some embodiments of the present disclosure;

FIG. 10 illustrates a flowchart of an example method implemented at a network device in accordance with some embodiments of the present disclosure; and

FIG. 11 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal, a wireless device or a reduced capability terminal device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHz), FR2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment. the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally speaking, one TRP usually corresponds to one SRS resource set. As used herein, the term “single-TRP” refers to that a single SRS resource set is used for performing related transmissions (such as, PUSCH transmissions), and the term “multi-TRP” refers to that a plurality of SRS resource sets are used for performing related transmissions (such as, PUSCH transmissions). The terms “SRI”, “SRS resource set index”, “UL TCI”, “UL spatial domain filter”, “UL beam”, “joint TCI” can be used interchangeably. It has been agreed that the maximum number of sounding reference signal (SRS) resource sets can be increased to two and two SRS resource indicator fields corresponding to two SRS resource sets can be introduced in DCI which schedules PUSCH transmissions. Regarding the CG PUSCH, the term “PUSCH transmission” used herein can refer to a nominal transmission or refer to an actual transmission.

The terms “transmission capability information”, “UE capability information”, “capability-related information”, “capability value set”, “panel information” and “panel-related information” can be used interchangeably;

The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;

The terms “single TRP”, “single TCI state”, “single TCI”, “S-TCI”, “single CORESET”, “single control resource set pool”, “S-TRP” and “S-TCI state” can be used interchangeably;

The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably:

The terms “resource(s)”, “resource(s) in a resource set”, “resource set” can be used interchangeably; and

The terms “group”, “subset”, “set” can be used interchangeably.

Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably.

In addition, panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID.

As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As used herein, the term “SRS transmission” refers to a transmission of SRS resource identified by SRS signal resource indicator (SRI) in a DCI message for uplink grant. Accordingly, term “the latest SRS transmission” refers to the latest transmission of SRS resource identified by SRI in a DCI message for uplink grant.

As used herein, the term “network”/“network device(s)” refer to one or more network devices. Accordingly, terms “network”, “network device(s)” and “one or more network devices” can be used interchangeably.

“BWP ID/index” can be used interchangeably with “BWP/CC ID/index”, “CC identity/index”, “cell identity/index”, “cell group identity/index”, “physical cell identity/index” and “serving cell identity/index”.

“beam failure” can be used interchangeably with “link failure”, “beam failure recovery request” can be used interchangeably with “link recovery request”.

As mentioned above, a terminal device is enabled to access to a communication system via a plurality of network devices. In this case, the terminal device may be required to apply different TA values to the uplink transmissions to different network devices, respectively, since the radio path between the terminal device and a network device may be different from the radio path between the terminal device and another network device. One solution is that a resource set for the terminal device is configured with a specific TA value, such that the terminal device may apply the specific TA value to a uplink transmission on the resource set. However, if a beam failure event is occurred between the terminal device and the network device, the TA value for the following uplink transmission should be further considered. In addition, the scheduling of uplink transmission for different network devices in a Time-Division Multiplexing (TDM) transmission and the applied TA values are also key aspect.

The example embodiments of the disclosure propose a mechanism for timing adjustment associated with a plurality of network devices. In this mechanism, a terminal device receives a first indication indicating a first timing advance (TA) value associated with a first set of Reference Signal (RS) resources. The terminal device receives a second indication indicating a second TA value associated with a second set of RS resources. In response to detecting a beam failure event associated with the first set of RS resources, the terminal device identifies a RS in the second set of RS resources and performs a first uplink transmission with the second TA value.

In this way, the terminal device may correctly transmit a Beam Failure Recover Request (BFRQ) and correctly transmit uplink channel after a Beam Failure Recovery (BFR) Procedure.

In addition, the example embodiments of the disclosure propose another mechanism for timing adjustment associated with a plurality of network devices. In the other mechanism, the terminal device receives a first indication indicating a first timing advance (TA) value associated with a first set of Reference Signal (RS) resources, the first set of RS resources is applied to a first transmission occasion of two consecutive transmission occasions. The terminal device receives a second indication indicating a second TA value associated with a second set of RS resources, the second set of RS resources is applied to a second transmission occasion of the two consecutive transmission occasions. The terminal device performs, based on an order mapping table indicating an order of the first transmission occasion and the second transmission occasion within the two consecutive transmission occasions, a second uplink transmission in the first transmission occasion with the first TA value and a third uplink transmission in the second transmission occasion with the second TA value.

In this way, the uplink transmissions with different TA values towards different network devices may be scheduled in a specific order indicated by the mapping order table. Further, the specific order can be indicated by reusing an existing indicator.

In this disclosure, T_{c} is a basic timing unit, where T_{c}=1/(Δfmax·N_{f}), Δfmax=480·10³ Hz, N_{f}=4096. Other time units can be a millisecond (ms), a frame, a subframe, a slot, a symbol, they can be converted to each other, and converted to Tc as following: frame length T_{f}=(Δfmax·N_{f}/100). T_{c}=10 ms, and each frame consisting of ten subframes. The number of consecutive OFDM symbols per subframe is N_{symb}^{subframe,μ}=N_{symb}^{slot}Nₛₗₒₜ^{subframe,μ}. Further, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. Further, other parameters associated with above timing unit conversion are shown in the following tables. Table 1 shows the supported transmission numerologies.

TABLE 1

| μ | Δf = 24^{μ} · 15 KHz | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

Table 2 shows number of OFDM symbols per slot, slots per frame, and slots per subframe for normal cyclic prefix.

TABLE 2

| μ | N_{symb}^{slot} | Nₛₗₒₜ^{frame, u} | Nₛₗₒₜ^{subframe, u} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

Table 3 shows number of OFDM symbols per slot, slots per frame, and slots per subframe for extended cyclic prefix.

TABLE 3

| μ | N_{symb}^{slot} | Nₛₗₒₜ^{frame, u} | Nₛₗₒₜ^{subframe, u} |
|---|---|---|---|
| 2 | 12 | 40 | 4 |

In this disclosure, the granularity of the adjustment of the TA values is 16·64/2^{μ}. One solution for indicating a TA value for a terminal device is that transmitting N_{TA} and N_{TA, offset} in an absolute TA command, a TA command, a Radio Resource Control (RRC) signaling or other signalings, where the N_{TA} and N_{TA, offset} are dimensionless integers. Then, the terminal device may calculate the TA value by the following equation (1):

$${T}_{TA} = ( {N}_{TA} + {N}_{TA , offset} + {N}_{TA , adj}^{common} + {N}_{TA , adj}^{UE} ) {T}_{c} \qquad ( 1 )$$

where the parameters N_{TA,adj}^{common} and N_{TA,adj}^{UE} are usually considered only in the Non-Terrestrial network, and can be omitted in this disclosure. Therefore, in this disclosure, the indication for TA values can be also realized as the indication for the parameters N_{TA} and N_{TA,offset}, since the terminal device may determine the real physical TA value based on these two parameters.

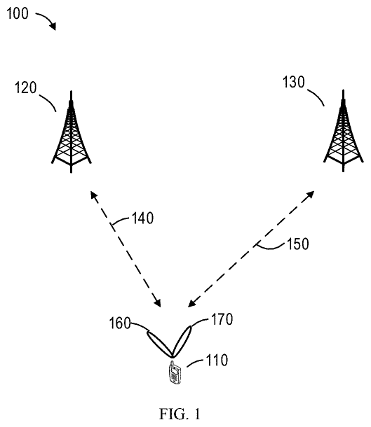

FIG. 1 illustrates an example environment 100 in which example embodiments of the present disclosure can be implemented.

The environment 100, which may be a part of a communication network, comprises a terminal device 110, a first network device 120 and a second network 130. The terminal device 110 may communicate with the first network device 120 via a uplink channel indicated by the reference number 140, and communicate with the second network device 130 via a uplink channel 150 indicated by the reference number 150. Further, the uplink channel 140 may be carried in a first beam assigned for the communication between the terminal device 110 and the first network device 120, the uplink channel 150 may be carried in a second beam assigned for the communication between the terminal device 110 and the second network device 130. In some cases, the terminal device is enabled to communicate utilizing multi-panels/antennas. Only for illustrating, two panels supported by the terminal device 110 are represented as the reference number 160 and the reference number 170, respectively, and these panels may be also referred as a first panel 160 and a second panel 170. It is to be understood that the terminal device 110 may have a first set of one or more beams based on beamforming on the first panel 160, and have a second set of one or more beams based on beamforming on the second panel 170. In addition, the first beam carrying the first uplink channel 140 may be comprised in the first set of one or more beams or the second set of one or more beams, and the second beam carrying the second uplink channel 150 may be comprised in the second set of one or more beams or the first set of one or more beams.

It is to be understood that the number of terminal devices and network device is shown in the environment 100 only for the purpose of illustration, without suggesting any limitation to the scope of the present disclosure. In some embodiments, the environment 100 may comprise a further terminal device to communicate information with a further network device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

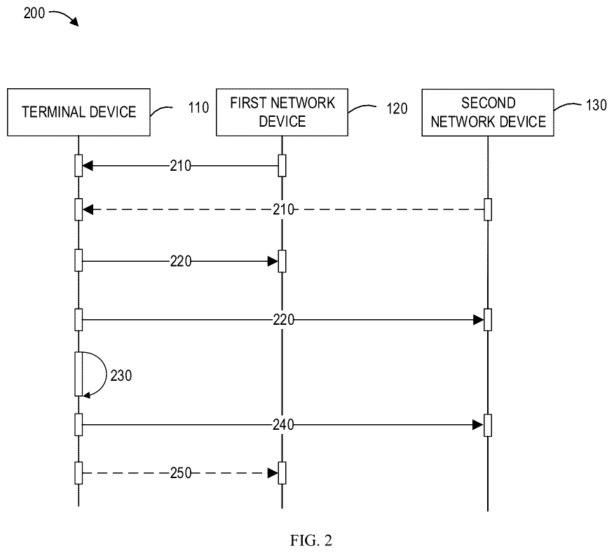

FIG. 2 illustrates a signaling process 200 for a timing adjustment associated with a plurality of network devices according to some embodiments of the present disclosure. For purpose of discussion, the process 200 will be described with reference to FIG. 1.

In the signaling process 200, the terminal device 110 receives (210) a first indication indicating a first TA value associated with a first set of Reference Signal (RS) resources. The terminal device 110 further receives (210) a second indication indicating a second TA value associated with a second set of RS resources. In some embodiments, for example, in a single Downlink Control Information (DCI) mode, the terminal device 110 may receive the first indication and the second indication from the first network device 120. In addition or alternatively, the terminal device 110 may also receive the first indication and the second indication from the second network device 130.

In some embodiments, for example, in a Multi-DCI mode, the terminal device 110 may receive the first indication and the second indication, respectively. For example, the terminal device 110 may receive the first indication from the first network device 120 and receive the second indication from the second network device 130. Without any limitation, the terminal device 110 may also receive the first indication from the second network device 130 and receive the second indication from the first network device 120.

In some embodiments, before receiving the first and second indications, the terminal device 110 may exchange capability information with the network devices 120 and 130. For example, the terminal device 110 may report the UE capability to the network devices 120 and 130. The UE capability may comprise the capability of supporting multi-TA values of the terminal device 110, the capability of multi-panels of the terminal device 110, the capability of multi-TA values of the terminal device 110 switch and so on.

Then, the network devices 120 and 130 may configure the first indication and second indication to the terminal device 110 in a RRC signaling. In addition or alternatively, the network devices 120 and 130 may configure the first indication and second indication to the terminal device 110 in a TA command.

In some embodiments, receiving the first indication and the second indication may comprise: receiving at least one first parameter indicating a TA value and at least one second parameter indicating a TA offset value. For example, receiving the first indication and the second indication may comprise receiving two N_{TA} parameters “N_{TA, 1} and N_{TA, 2}” which indicate TA value and two N_{TA, offset} parameters “N_{TA, offset, 1} and N_{TA, offset, 2}” which indicate TA offset value. Then, the terminal device 110 may determine the first TA value “T_{TA,1}” and the second TA value “T_{TA,2}” based on the following equation (2):

$$\{ \begin{matrix}{T}_{TA , 1} = ( {N}_{TA , 1} + {N}_{TA , offset , 1} ) {T}_{c} \\ {T}_{TA , 2} = ( {N}_{TA , 2} + {N}_{TA , offset , 2} ) {T}_{c}\end{matrix} \qquad ( 2 )$$

In addition or alternatively, receiving the first indication and the second indication may comprise receiving one N_{TA} parameter “N_{TA}” and two N_{TA, offset} parameters “N_{TA, offset, 1} and N_{TA, offset, 2}”. Then, the terminal device 110 may determine the first TA value and the second TA value based on the following equation (3):

$$\{ \begin{matrix}{T}_{TA , 1} = ( {N}_{TA} + {N}_{TA , offset , 1} ) {T}_{c} \\ {T}_{TA , 2} = ( {N}_{TA} + {N}_{TA , offset , 2} ) {T}_{c}\end{matrix} \qquad ( 3 )$$

In addition or alternatively, receiving the first indication and the second indication may comprise receiving two N_{TA} parameters “N_{TA, 1} and N_{TA, 2}” and one N_{TA, offset} parameter “N_{TA, offset}”. Then, the terminal device 110 may determine the first TA value and the second TA value based on the following equation (4):

$$\{ \begin{matrix}{T}_{TA , 1} = ( {N}_{TA , 1} + {N}_{TA , offset} ) {T}_{c} \\ {T}_{TA , 2} = ( {N}_{TA , 1} + {N}_{TA , offset} ) {T}_{c}\end{matrix} \qquad ( 4 )$$

In addition or alternatively, receiving the first indication and the second indication may comprise receiving one N_{TA} parameter “N_{TA}”, one N_{TA, offset} parameter “N_{TA, offset}” and another offset value “N_{TA, offset, add}” which also indicates an additional TA value. Then, the terminal device 110 may determine the first TA value and the second TA value based on the following equation (5):

$$\{ \begin{matrix}{T}_{TA , 1} = ( {N}_{TA ,} + {N}_{TA , offset} ) {T}_{c} \\ {T}_{TA , 2} = ( {N}_{TA ,} + {N}_{TA , offset} + {N}_{TA , offset , add} ) {T}_{c}\end{matrix} \qquad ( 5 )$$

In some embodiments, the parameters N_{TA,offset}, N_{TA,offset,1}, N_{TA,offset,2} are transmitted in the RRC signaling, the parameters N_{TA}, N_{TA, 1}, N_{TA, 2} and N_{TA, offset, add} are transmitted in the DCI signaling or a MAC Control Element (CE). In some embodiments, the RRC signaling, the DCI signaling and MAC CE may be combined for transmitting the above parameters associated with the first and second TA values.

In some embodiments, the TA values (for example, N_{TA}, N_{TA, 1}, N_{TA, 2} and N_{TA, offset, add}) are transmitted in a Random Access Response (RAR), an absolute TA command signaling, or a TA command. If TA values (e.g., T_{A,1} and T_{A,2}) are transmitted in RAR or absolute TA command, they are in an absolute value form (e.g., via 12-bit), for example, N_{TA,1}=T_{A,1}·16·64/2^{μ} and N_{TA,2}=T_{A,2}·16·64/2^{μ}. If TA values (for example, T_{A,1} and T_{A,2}) are transmitted in TA command (e.g., in 6-bit), they are in a relative form, for example, N_{TA_new,1}=N_{TA_old,1}+(T_{A,1}−31)·16·64/2^{μ}, and N_{TA_new,2}=N_{TA_old,2}+(T_{A,2}−31)·16·64/2^{μ} and the correspondence between old and new TA value is associated with the same network device, the same beam or the same UE panel. Further, the TA offset values (for example, N_{TA,offset}, N_{TA,offset,1}, N_{TA,offset,2}) are transmitted in RRC configurations or pre-defined. In addition or alternatively, if multiple TA values are configured or indicated to only one or a subset of TA values can be applied, a default TA value is needed. For example, TA value during initial access or random access can be treated as the default TA value. In another example, the default TA value can be the smallest, the largest, the first TA value, or the last TA value of multiple configured or indicated TA values. In addition or alternatively, for multiple BWPs/CCs, the same pair of TA values (measured in absolute transmission occasions) is ensured across BWPs/CCs, so that change of BWP/CC will not impact on the TA values. In addition or alternatively, if TA values are configured per BWP/CC and are SCS dependent, the TA values configured with minimum or maximum SCS are applied or the TA values with maximum or minimum absolute time length are applied.

In this disclosure, the first and second sets of RS resources may represent any of communication resource types being used for the Multi-TRP communication between the terminal device 110 and network devices 120 and 130. For example, the received indication may indicate that the association between the TA values and network devices/beams/UE panels has been established. Accordingly the change of TRP/beam/UE panel leads to the change of applied TA. For example, the first indication or second indication may be directly contained in a respective RS resource configuration for the terminal device 110. In this way, the terminal device 110 may determine a TA value associated with a set of RS resources implicitly. For example, receiving the first indication may comprise receiving a first configuration for the first set of RS resources having the first TA value. Similarly, receiving the second indication may comprise receiving a second configuration for the second set of RS resources having the second TA value. In addition or alternatively, the associations may be explicitly indicated in a TA command directly. In some embodiments, the associations may be also indicated in a RRC signaling. In some other embodiments, the associations may be indicated in any other signaling explicitly or implicitly. In addition or alternatively, the indication of the association includes information of the TA values, RS sets, and their mapping relationships. As such, the terminal device may derive the associations between TA values and the set of RS resources directly or indirectly. In addition, the first and second sets of RS resources may be any type of set of RS resources, for example, the set of CSI-RS resources, the set of SRS resource set, or the set of SS/PBCH blocks.

The first and second sets of RS resources may be a set of RS resources for a TRP, for example, a set of RS resources for the first network device 110, another set RS resources for the second network device 120. In this case, the first set of RS resources may be represented as any of: CORESETPoolIndex 0, or DCI 1. The second set of RS resources may be represented as any of: CORESETPoolIndex 1, DCI 2. In turn, the first TA value may be associated with a specific RS resource set and the second TA value may be associated with another specific RS resource set accordingly.

In some embodiments, the set of RS resources may be a set of RS resources for a spatial filter (for example, a beam). In this case, the first set of RS resources may be represented as Transmission Configuration Indicator (TCI) state 1 and the second set of RS resources may be represented as TCI state 2. In addition or alternatively, the set of RS resources may be a set of RS resources for a UE panel, for example, the first set of RS resources may be represented as UE panel 1 and the second set of RS resources may be represented as UE panel 2.

In addition or alternatively, the first set of RS resources may be also represented as a Beam Failure Detection (BFD) RS set associated with the first network device 120 and/or a Candidate Beam Detection (CBD) RS set associated with the first network device 120. In turn, the second set of RS resources may be also represented as the BFD RS set associated with the second network device 130 and/or the CBD RS set associated with the second network device 130.

In addition or alternatively, in some embodiments, the first set of RS resources may be represented as the BFD RS set. The second set of RS resources may be represented as the CBD RS set. In this case, the BFD RS set may comprise at least one of the BRD RS sets associated with the first network device 120 and the second network device 130. The CBD RS set may comprise at least one of the CBD RS sets associated with the first network device 120 and the second network device 130.

With the above associations between TA values and the sets of RS resources, associations between TA values and TRPs, associations between TA values and beams, or associations between TA values and UE panels, the terminal device and network device may determine a corresponding TA value based on a RS resource set, a TRP, a beam or a UE panel for the terminal device. Once the RS resource set, the TRP, the beam, or the UE panel is switched, the applied TA value may be switched at terminal device and network device accordingly. Further, in some embodiments, there may be a further TA command indicating the updated first and second TA values, then, the TA values may be updated upon the TA command is acknowledged by the terminal device. For example, signaling/procedure/condition for switching TRP/beam/UE panel may be the implicit signaling of the change of applied TA. In addition or alternatively, if terminal device request to change of applied TRP/beam/UE panel, the applied TA value may be changed accordingly.

In addition or alternatively to the RS resource set, the first TA value and the second TA value may be also associated with a UL channel resource.

In addition or alternatively to the RS resource set, the TA value may be associated with a Component Carrier (CC) or a Bandwidth Part (BWP). For example, the first TA value may be associated with BWP 0, and the second TA value may be associated with BWP 1, 2 and 3. In this way, with establishing the association between TA values and CCs/BWPs, the change of CCs/BWPs leads to the change of applied TA value. Signaling/terminal request of the change of CCs/BWPs may be the implicit signaling of the change of applied TA and vice versa. CC/BWP may be represented as CC ID or BWP ID and may be extend to one or many of the following: cell index, cell group ID, PCI, band information, band combination information.

In the above embodiments, the number of TA values is equal to the number of network devices to which the terminal device 110 is connected, since the radio path between a terminal device and a network device is considered. For further refining the timing adjustment, the number of panels at terminal device may be further considered, since the radio path between a first panel of the terminal device 110 and the first network device 120 may be different from the radio path between a second panel of the terminal device 110 and the first network device 120.

Referring back to FIG. 1, for example, the radio path between the first panel 160 and the first network device 120 may be different from the radio path between the second panel 170 and the first network device 120. In this case, the number of the panels at the terminal device 110 should be considered. For example, in this case, there may be four indications of which each indicates a TA value applied to a respective radio path between a panel to a network device. Further, in this case, when exchanging capability information with the network devices 120 and 130, the terminal device 110 may further report whether the terminal device 110 supports multi-TA values for multi-panels. In addition, the capability information may provide whether the terminal device 110 can support any of: same TA (or the number of TAs) for multiple uplink panels, same TA (or the number of TAs) for multiple UL panels for the same network device.

Referring back to FIG. 2, after determining the corresponding TA values based on the first and second indication, the terminal device performs (220) uplink transmissions with the corresponding TA value to the first network device 120 and the second network device 130, respectively. For example, the terminal device 110 may be configured with CORESETPoolIndex 0 associated with the first network device 120 and be configured with CORESETPoolIndex 1 associated with the second network device 130. In addition, the CORESETPoolIndex 0 has the first TA value, and the CORESETPoolIndex 1 has the second TA value. Then, the terminal device 110 may perform a uplink transmission to the first network device 120 with the first TA value and perform a uplink transmission to the second network device 130 with the second TA value.

For ensuring the accuracy of the TA values, some further adjustment on the indicated TA values may be required.

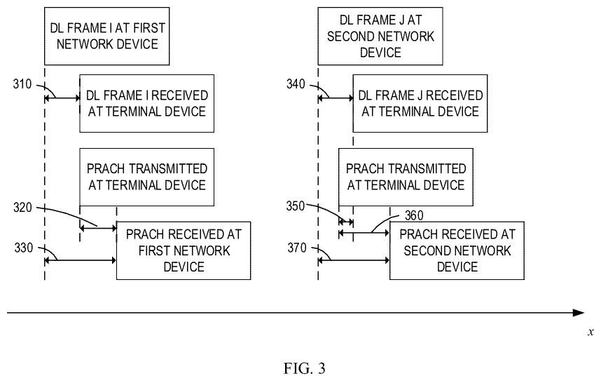

In some situations, the TA value is calculated during a physical random access procedure on a Physical Random Access Channel (PRACH) under assuming that the PRACH is not applied a TA value or is applied a TA value of zero. However, in some situations, some PRACH may be applied a specific TA value. In this case, the calculated TA value may be inaccuracy. For discussion clarity; the adjustment associated with PRACH with TA value may be discussed with reference to FIG. 3.

FIG. 3 illustrates a timing adjustment for TA value according to some embodiments of the present disclosure. For purpose of discussion, the timing adjustment will be described with reference to FIG. 1.

In FIG. 3, the blocks in left column show the TA value determination if PRACH is transmitted with zero TA, blocks in right column show the TA value determination if PRACH is transmitted with non-zero TA. Without any limitation, for example, assuming that the PRACH towards to the first network device 120 is applied a TA value of zero, and the PRACH towards to the second network device is applied a TA value of non-zero. It is to be understood that the TA value of non-zero may be also applied to the PRACH towards the first network device 110 and any other PRACH in the MTRP communication. In some embodiments, whether the TA value applied to the PRACH is zero depends on the functionality of PRACH transmission or the trigger condition of the PRACH. For example, if the PRACH is used for synchronization, or the PRACH is a contention based PRACH or PDCCH order triggered PRACH, the applied TA value is equal to 0. In another example, if the PRACH carries additional information, for example, a PRACH during a BFR procedure carries information associated with a recovery beam, or a PRACH in a two-step Random Access (RA) procedure, the transmission of PRACH may be applied a non-zero TA value. In a yet example, the network device may inform the terminal device 110 whether to apply non-zero TA when transmitting PRACH.

In the FIG. 3, x-axis represents the time domain. For the TA value calculation by the first network device 120, the first network device 120 transmits a DL frame i at a first time occasion. Upon receiving the DL frame i by the terminal device 110 at a second time occasion, the terminal device 110 transmits the PRACH to the first network device 120. The network device 110 may determine the TA value for the terminal device 110 based on measuring the timing difference. In FIG. 3, the length 310 represents the time delay from the first network device 120 to the terminal device 110 and the length 320 represents the time delay from the terminal device 110 to the first network device 120. Usually, according to the reciprocity of the channel, the length 310 equals to the length 320. Then, the first network device 120 may determine the first TA value for the terminal device 110 by measuring the time delays in opposite directions. In FIG. 3, the time length 330 of the first TA value may equal to the length 310 plus length 320.

For the TA value calculation by the second network device 130, assuming that the terminal device 110 will transmit the PRACH with a non-zero TA value. The second network device 130 transmits a DL frame j to the terminal device 110 at a third time occasion (it is to be understood that the third time occasion may be same as the first time occasion or the second time occasion). The time delay from the second network device 130 to the terminal device 110 is represented as time length 340. Since the PRACH is applied a non-zero TA value, the terminal device 110 may transmit PRACH to the second device 130 before receiving the DL frame j. In an example, the time difference (non-zero TA value) between the PRACH transmission and the receiving of the DL frame j is represented as the time length 350 in FIG. 3. Then, if without considering a non-zero TA value, the second network device 130 may determine the timing difference as the time length 370. However, from the repective of the second network device 130, the time length 350 (or, the TA value of non-zero applied to the PRACH towards to the second network device 130) has decreased the transmission delay 360 from the second network device 130 to the terminal device 110. For ensuring the accuracy of TA value, the second network device 120 should adjust the second TA value for the terminal device 110 by the non-zero TA value for the PRACH. In the example of FIG. 3, the second TA value is equal to the measured time length 370 plus the non-zero TA value 350 for the PRACH. It is to be understood that the above situation is only an example, in some embodiments, the PRACH towards to the first network device 120 is also applied with a non-zero TA value. Then, the first network device 120 should adjust the first TA value for the terminal device 110 accordingly.

In an example, in the MTRP communication case, T_{TA,1}=T′_{TA,1}+Δ1, T_{TA,2}=T′_{TA,2}+Δ2, where T′_{TA,1}, T′_{TA,2} are TA values indicated in the first and second indications by network device, for example, in a RAR signaling, Δ1 and Δ2 may be the same or different. In addition or alternatively, whether applying the adjustment to the TA value may be informed by the network device in a RAR signaling. In addition or alternatively, the network device may also inform the terminal device 110 whether to apply a non-zero TA value.

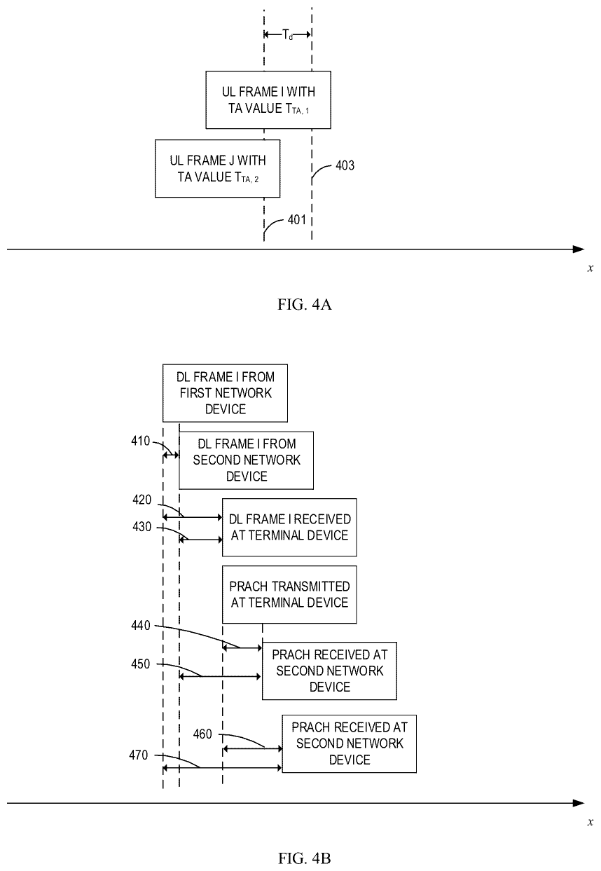

In addition to the situation of a PRACH transmission with non-zero TA value, there may be other situations which the TA values should be further adjusted. In some embodiments, the downlink channel transmissions from the network devices are not synchronized or asynchronous. In this case, the first TA value and/or second TA value should be further adjusted based on the time-domain difference between the timing sychronizations for network devices. In addition, the adjustments are based on selecting one network device as a reference network device. The TA adjustment with respect to asynchronization network devices may be discussed in detail with reference to FIG. 4A and FIG. 4B.

FIG. 4A and FIG. 4B illustrate a timing adjustment for TA value according to some embodiments of the present disclosure. For purpose of discussion, the timing adjustment will be described with reference to FIG. 1.

In FIG. 4A, the downlink channel transmission 401 from the second network device 130 and the downlink channel transmission 403 from the first network device 120 (DL frame i from the first network device in FIG. 4) (DL frame i from the second network device in FIG. 4) are asynchronous. In an example, the timing difference is T_{d}. For ensuring the timing sychcronization of uplink transmissions, the timing difference T_{d} should be considered. In some embodiments, a time domain reference or a reference network device is determined to adjust the first and second TA values for the terminal device 110. For example, if DL frame i from the first network device is selected as the reference network device, then the second TA value is further adjusted to the indicated second TA value plus T_{d}. In addition or alternatively, if the second network device 130 is selected as the reference network device, then the first TA value is further adjusted to be the indicated first TA value minus T_{d}.

In addition or alternatively, in some embodiments, the timing difference between these two downlink channel transmissions is compensated at network side. As shown in FIG. 4B, the timing difference between these two downlink channel transmissions is the time length 410. In addition, the time length 420 is the time delay from the first network device 120 to the terminal device 110, the time length 430 is the time delay from the second network device 130 to the terminal device 110. In turn, the time length 440 is the time delay in a respective opposite direction. The time length 460 is the time delay in another respective opposite direction. In this case, at network device side, the timing difference 410 (corresponding to the above T_{d}) is compensated in advance, such that the DL frame i from different network devices 120 and 130 are arrived at the terminal device 110 simultaneously or during a tolerable delay. Once receiving the DL frame i, the terminal device 110 may transmit a PRACH without applying TA applied. Then, the network devices 120 and 130 can determine the appropiate TA values for the terminal device 110 under timing asynchornization between network devices. Then, the network devices indicates the determined TA values as the first and second TA values to the terminal device 110.

In some embodiments, the T_{d} or the time length 410 may consist of at least one of: timing difference existed at network devices: timing difference observed at terminal device side, for example, reference signal timing difference: timing difference observed at different terminal device panels.

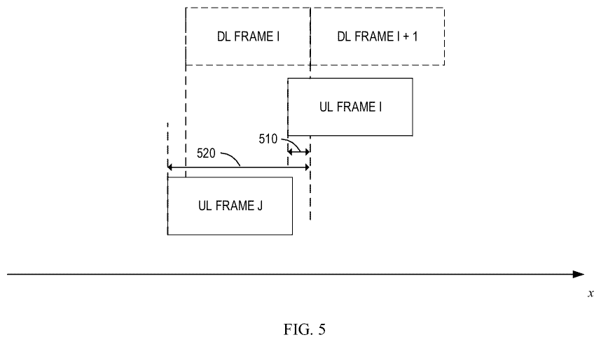

Referring back to FIG. 2, in some embodiments, the difference between the first TA value and the second TA value should be restricted in order to coordinate the uplink transmission from the terminal device 110 and the downlink channel transmission to the terminal device 110. For discussion clarity, the restrictions on the first and second TA values may be discussed with reference to FIG. 5.

FIG. 5 illustrates a restriction on a plurality of TA values according to some embodiments of the present disclosure. For purpose of discussion, the timing adjustment will be described with reference to FIG. 1.

In FIG. 5, expected downlink transmission timing is shown for reference. The time length 510 represents the first TA value for the uplink transmission to the first network device 120 and the time length 520 represents the second TA value for the uplink transmission to the second network device 130. For avoiding the overlaps between uplink transmission to the first network device 120 or the second network device 130 and the downlink channel transmission from the second network device 130 or the downlink channel transmission from the first network device 120, the timing difference value between the first TA value and the second TA value should be smaller than a first threshold. For example, if the difference value is very large, the end of a downlink channel transmission frame associated with the smaller TA value may be overlapped with the beginning of uplink transmission frame associated with the larger TA value.

In some embodiments, the first threshold may be determined based on at least one of: Cyclic Prefix (CP) length, Tx-Rx transition time, downlink-uplink transition time, maximum uplink transmission timing difference, timing tolerance related to cell size, timing tolerance related to the path length between different network devices and the terminal device. In addition, the value of the threshold may also cover the beam switch time, the panel switch time, or TRP timing difference.

In addition or alternatively, the first threshold may be predefined, or based on at least one of: signaling via NW, or reported by terminal device as terminal capability or suggestion. In addition or alternatively, the first threshold may be different for different frequency range, SCS, band/band combination, cell/cell group, BWP. In addition or alternatively, the first threshold is applied for each of TA values. In addition or alternatively, the overlapped or partial-overlapped slot is dropped. In addition or alternatively, the overlapped or partial-overlapped slot is not used for transmission. In addition or alternatively, the latter slot is reduced in duration relative to the former slot.

In some embodiments, the timing difference value between the first TA value and the second TA value may be larger than a second threshold. In some embodiments, the second threshold may be determined or predefined in the similar way as the first threshold.

Referring back to FIG. 2, the terminal device may apply the first TA value and the second TA value to the respective uplink transmission at a certain time occasion. In some embodiments, the first TA value and the second TA value are applied conditionally. In some embodiments, the conditions of enabling the first and second TA value are predefined between the terminal device 110 and the network devices 120 and 130 such that the first and second TA values can be applied simultaneously.

In some embodiments, the first TA value and the second TA value are applied respectively. For example, if the first and second TA values are indicated in the explicit or implicit signaling (as discussed as above, TA command, RAR signaling, RRC signaling and so on), the indicated TA values is applied respectively as following:
if the signaling is via the TA command, for example, MAC CE, the first and second TA value are applied after n+k+1+2^{μ}·K_{offset}, wherein the n is time slot when the signaling is received or the signaling is acknowledged by the terminal device 110 in a ACK signaling, and k=[Nₛₗₒₜ^{subframe, μ}·(N_{T,1}+N_{T,2}+N_{TA,max}+0.5)/T_{sf}]; and
If the signaling is via DCI, n+y+1 (optionally+2^{μ}·K_{offset}) where y is smaller than k, for example, replace N_{T,1} to PDCCH decoding time, and the n is time slot when the signaling is received or the signaling is acknowledged by the terminal device 110 ACK signaling.
   In addition, the first TA value from slot n+k1+1 and the second TA value from n+k2+1, wherein k1 and k2 are required durations for adjusting TA values per network device respectively.

In M-DCI mode, parameter n associated with the first network device 120 and parameter n associated with the second network device 130 can be considered respectively, since the terminal device 110 may receive DCI 1 and DCI 2 and change the first TA and second TA values separately.

In addition or alternatively, the first and second TA values may be applied at a same time, the latter one of the timing occasion when the corresponding TA can be applied (for example, n+k+1+2^{μ}·K_{offset}). In addition or alternatively, more time is needed to switch multiple TA values, for example, from slot n+k′+1, k′>k if the singling contains more than one TA values.

In some embodiments, the first and second TA values may be applied at least partially based on the beam switch procedure. In an example, the signaling of beam switch also implicitly indicates the change of TA values. As such, the first and second TA value are indicated at least partially based on beam switch procedure is performing. The terminal device 110 may enable the first and second TA values upon the beam switch procedure being completed. For example, the timing of applying new beam and the time applying new TA should be aligned, the application timing is the latest time of applying new beam and applying new TA values, or is at least on of the following: TA application timing, and beam switch timing. In turn, the terminal device 110 may determine the latest time occasion of a time occasion when the TA values can be applied (for example, n+k+1+2^{μ}·K_{offset} for MAC CE, n+y+1 for DCI) and another time occasion when the beam switch procedure is completed (for example, n+3 ms for MAC CE, or n+beam application timing for DCI). In an example, the parameter “n” in TA value application timing is the slot when the terminal device 110 receives the command, the parameter “n” in beam switch application timing is the slot when the terminal device 110 sends HARQ-ACK to the channels carrying the command.

In addition or alternatively, the first and second TA values may be applied at least partially based on a power control procedure. For example, the first and second TA value are indicated while the power control procedure is performing, or signaling of beam switch also indicated the change of uplink power, for example, the change of path loss reference signal, or a signaling indicates both beam switch, change of path loss reference signal and the change of TA value. The terminal device 110 may apply the first and second TA values upon the power control procedure being completed. For example, the timing of to applying new beam, new TA, new PL RS should be aligned, and the application timing is then the maximum of: TA command application timing, beam switching timing, path loss RS switching timing/

Alternatively, the above application timing of the first and second TA values may be also expressed as following:

If ACK feedback corresponds to a command to switch TCI state and TA received on uplink
slot n, the corresponding TCI state and the adjustment of the uplink transmission timing
applies from the beginning of uplink slot max (n + k + 1 + 2^{μ} · K_{offset}, n +
3Nₛₗₒₜ^{subframe, μ})
If ACK feedback corresponds to a command to switch TCI state and TA received on uplink
slot n, the corresponding TCI state and the adjustment of the uplink transmission timing
applies from the beginning of uplink slot max (n + k + 1 + 2^{μ} · K_{offset}, n +
beamapplicaiton timing).

Regarding the valid duration for the first and second TA values, there may be a configured timer for these TA values. In some embodiments, the first TA value is configured with a first timer and the second TA value is configured with a different second timer. In addition or alternatively, the first TA value and the second TA value are configured with a same third timer. In these cases, a corresponding timer is triggered to start or restart based on receiving an indication indicating a corresponding TA value. For example, if the first and second TA values are configured respective timers, the timer configured for the first TA value may be triggered to start or restart when receiving the first indication. In another example, if the first TA value and second value have a same configured timer, if any of the first indication and the second indication is received by the terminal device 110, the same configured timer is started or restarted.

In some embodiments, the timer may be also triggered to start or restart when the terminal device 110 switches between the sets of RS resources without needing to receive the first and second indications.

In addition, any timer of the above first, second and third timers may be determined as expired based on at least one of: running time of the at least one timer reaches corresponding expiration time: a first maximum uplink transmission timing difference between a plurality of TA values is exceeded, each of the plurality of TA values being associated with a respective network device: a second maximum uplink transmission timing difference between a plurality of network devices is exceeded, each of the plurality of network devices being associated with a respective TA group of a Medium Access Control (MAC) entity: and a third maximum uplink transmission timing difference between a plurality of network devices is exceeded, each of the plurality of network devices being associated with a respective TA group of a Medium Access Control (MAC) entity of the terminal device.

Once the timer is determined as expired, the terminal device 110 may perform corresponding operations. The corresponding operations may comprise: flushing all HARQ buffers for the corresponding network device: notifying RRC to release Physical Uplink Control Channel (PUCCH) for the corresponding network device: notifying RRC to release SRS for the corresponding network device: clearing any configured downlink assignments and configured uplink grants for the corresponding network device: clearing any Physical Uplink Shared Channel (PUSCH) resource for semi-persistent Channel State Information (CSI) reporting for the corresponding network device: considering all running timeAlignmentTimers for the corresponding network device as expired: maintaining NTAs for the corresponding network device. If the timer is configured for all TA values (for example, the timer is configured for all the network devices), the corresponding network device may be all these network devices.

In view of above, the terminal device 110 may determine and apply the correct TA values to the respective uplink transmission to a network device. In this way, in MIMO communication, the terminal device may process the timing adjustment properly and coordinate the timing adjustment with other resource configuration or power control procedure properly:

Referring back to FIG. 2, in the MIMO communication (or for example, Multi-Transmission Reception Points-MTRP communication), the terminal device may experience a Beam Failure event associated with a network device of multi-network devices serving the terminal. For example, the beam assigned for the downlink channel transmission 140 from the first network device 120 to the terminal device 110 may be failed. In this case, the terminal device 110 may initiate a BFR recovery procedure accordingly. For the BFR recovery procedure in the MTRP communication, which TA value should be applied to a Beam Failure Recovery Request (BFRQ) and the following uplink transmission may be further considered.

As mentioned above, the first and second sets of RS resource associated with the first and second TA values may also comprise the BFD RS set and CBD RS set. In some embodiments, the first TA value may be associated with any of RS sets for the first network device 120, the second TA value may be associated with any of RS sets for the second network device 130. As shown in the following table 4, the first TA value is associated with the CORESETPoolIndex 0 for the first network device 120, is associated with the BFD-RS set q_(0, 0) for the first network device 120 and is associated with the CBD-RS set q_(1, 0) for the first network device 120. The BFD-RS set comprises one or more beam failure detection-reference signals for detecting the beam failure associated with the first network device. The CBD-RS set comprises one or more candidate beam detection reference signals for selecting candidate beam for the recovery procedure.

TABLE 4

| TA values | CORESET | BFD-RS set | CBD-RS set |
|---|---|---|---|
| First TA | CORESETPoolIndex0 | BFD-RS set q_(0, 0) | CBD-RS set q_(1, |
| value | | | 0) |
| Second TA | CORESETPoolIndex1 | BFD-RS set q_(0, 1) | CBD-RS set q_(1, |
| value | | | 1) |

In turn, the second TA value is associated with respective RS set for the second network device 130. In addition or alternatively, in some other embodiments, the second TA value may also be associated with the BFD-RS set and CBD-RS set for the second network device 130, for example, BFD-RS set q_(0, 1) and CBD-RS set q_(1, 1).

The terminal device 110 may declare (230) that detecting a beam failure for the BFD-RS set q_(0, 0). For example, the beam failure may be caused by any of: the first network device 120 is failed, or the link quality is worse than a threshold. In addition or alternatively, the terminal device 110 may declare that detecting a beam failure for both the BFD-RS set q_(0, 0) and the BFD-RS set q_(0, 1).

With the above situation, the terminal device 110 may try to recover to the second network device 130. In an example, if the terminal device 110 try to recover to the second network device 130, the terminal device 110 may select a RS (which may be also referred as “q_new”) the CBD-RS set q_(1, 1). The q_new corresponds to a recovery beam for the second network 130. Then, the terminal device 110 may select a candidate beam corresponding to the q_new of which the LI-RSRP parameter is above a predefined threshold as the recovery beam. In addition or alternatively, even no RS in the CBD-RS set q_(1, 1) satisfies the predefined threshold, the applied TA to the following uplink transmission will be adjusted to TA associated with the second network device 130. For example, in MTRP communication, if the first TRP is failed, stop applying the first TA associated with the first network device 110 and start applying the second TA value associated with second network device 120. In addition or alternatively, in MTRP communication, if the first panel of the terminal device 110 is failed, stop applying the first TA associated with the first panel and start applying the second TA associated with a second panel.

In this case, the terminal device 110 may transmit (240) a Beam Failure Recovery Request (BFRQ) with the second TA value associated with the recovery beam, since the terminal device 110 determines the recovery beam from the CBD-RS set q_(1, 1). Accordingly, after transmitting the BFRQ, or after receiving the response to the BFRQ, the terminal device 110 may also perform (240) the uplink transmission with the second TA value associated with the recovery beam until receiving a new indication indicating TA values. In some embodiments, the uplink transmission may comprise PUCCH, PUSCH and SRS. In some embodiments, the response to the BFRQ can be RAR, a first PDDCH PDCCH reception in a search space set provided by recovery SearchSpaceId for which the UE detects a DCI format with CRC scrambled by C-RNTI (Radio Network Temporary Identity) or MCS-C-RNTI, or a PDCCH reception with a DCI format scheduling a PUSCH transmission with a same HARQ process number as for the transmission of the first PUSCH and having a toggled new data indicator (NDI) field value. In some embodiments, the new indication can be the configuration, activation, or indication of at least one of the following: beam indication, TCI state, UL TCI state, spatial relation, BWP/CC switch. In addition, the terminal device 110 may further inform information associated with the recovery beam to the network in the BFRQ.

In addition or alternatively, if PUCCH-Scheduling Request (SR) or PUSCH is configured with other beam(s) which are not failed, the TA values associated with that beam may be applied. In addition or alternatively, if there are multiple PUCCH-SR or PUSCH resources, the resources with the same TA as the recovery beam is selected as the resource for sending the BFRQ. In addition or alternatively, if there are multiple beams for one or many PUCCH-SR or PUSCH resources, the beam and/or resource with the same TA as the recovery beam is selected as the beam and/or resource for sending the BFRQ.

In some embodiments, the terminal device 110 may also transmit a BFRQ with a default TA value. The default TA value may be determined from at least one of: zero, the first TA value, the second TA value, a TA value applied before BFD and a TA value applied to a latest successful uplink transmission. For example, if the beam failure is considered as an out-of-sync case, then the terminal device 110 may transmit a BFRQ with TA value of zero. In addition or alternatively, if the BFRQ is a PRACH-based BFRQ or a contention-based PRACH-based BFRQ, then the terminal device 110 may transmit a BFRQ with TA value of zero. In addition or alternatively, the default TA value may be equal any of the first and second TA values, the maximum of the first and second TA values, the minimum of the first and second TA values, or the first TA value plus the second TA value, and so on. In addition or alternatively, the terminal device 110 may also transmit the following uplink channel with the default TA value. In some embodiments, the terminal device 110 may also transmit a BFRQ with a TA value depending on the UL channels used for BFRQ, for example, PUSCH BFRQ, PUCCH-SR BFRQ, contention-free RACH, or msg.A is transmitted with non-zero TA, PRACH-based BFRQ is transmitted with zero TA.

In some embodiments, the terminal device 110 may also transmit a BFRQ with a third TA value associated with an uplink channel resource for the BFRQ. For example, if the terminal device 110 still selects a recovery beam from CBD-RS set q_(1, 0) for the first network device 120, the terminal device 110 may transmit a BFRQ with a third value associated with an uplink channel resource for the BFRQ, since the first network device 120 is considered to be failed. In addition, if multiple UL resources are available, some priority rule can be defined. For example, the priority is based on associated TA value, for example, the larger/smaller TA value, the same/different TA value compared to the selected recovery beam, and so on.

In response to the transmitted BFRQ, a network device may transmit a BFRQ response to the terminal device 110. In some embodiments, the BFRQ may comprise an updated TA value, this updated TA value may be referred as a third TA value. Then, the terminal device 110 may perform further uplink transmission with the third TA value. For example, the BFRQ response may contain information about TA adjustment. The BFRQ may be comprised in, for example, the first and second indications as discussed above, such as, in RAR signaling. In an example, the BFRQ contains only one valid TA value which corresponds to the q_new. In this case, if multiple TA value indicated, ignore the other TA values. In addition or alternatively, the BFRQ may contain information for triggering UL timing alignment of channels/signals. In this case, the terminal device 110 needs to send PRACH or SRS with TA value=0) for acquiring new timing requirement. Network devices then transmit RAR or TA command to adjust TA applied.

In addition or alternatively, the network device may transmit specific indication indicating an updated TA value, which may be also referred as a fourth TA value. Then, the terminal device 110 may perform further uplink transmission with the fourth TA value. In some embodiments, the terminal device 110 may receiving the fourth TA value in the same way as the first and second TA values. For example, the specific indication may contain information about TA adjustment. The specific indication may be comprised in, for example, the first and second indications as discussed above, such as, in RAR signaling. In an example, the specific indication contains only one valid TA value which corresponds to the q_new. In this case, if multiple TA value indicated, ignore the other TA values. In addition or alternatively, the specific indication may contain information for triggering UL timing alignment of channels/signals. In this case, the terminal device 110 needs to send PRACH or SRS with TA value=0 for acquiring new timing requirement. Network devices then transmit RAR or TA command to adjust TA applied.

In this way, once a beam failure event is occurred in M-TRP communication, the terminal device may determine appropriate TA value for transmitting BFRQ and uplink channel based on, for example, selecting the recovery beam. In turn, the terminal device may transmit UL signals and channels correctly.

In addition or alternatively, for the beam failure recovery procedure, the first TA value and second value may be associated with the BFD-RS set and the CBD-RS set in an approach different from the above table 4. For example, the first TA value may be associated with a BFD-RS set q_(0) comprising all the BFD-RSs and the second TA value may associated with a CBD-RS set q_(1) comprising all the CBD-RSs. In this case, the terminal device 110 may transmit the BFRQ and uplink channel with the second TA value. Further, other BFR configurations include BFR timer, BFD timer, BFI counter and max value, BFD and CBD thresholds, UL resources for BFRQ transmissions, CORESET/search space for monitoring BFR response, power, power ramping, retransmission counter and max value, and so on. They can be configured per UE, or per TRP. They can be configured per BWP/CC/CC group/band/band combination.

Alternatively, the above BFR procedure in MTRP communication may be also expressed as following three alternative description:

For the PCell or the PSCell, after 28 symbols from a last symbol of a first PDCCH
reception in a search space set provided by recoverySearchSpaceId for which the UE
detects a DCI format with CRC scrambled by C-RNTI or MCS-C-RNTI and until the UE
receives an activation command for PUCCH-SpatialRelationInfo [11, TS 38.321] or is
provided PUCCH-SpatialRelationInfo for PUCCH resource(s), the UE transmits a PUCCH
on a same cell as the PRACH transmission using
a same spatial filter as for the last PRACH transmission
a power determined as described in clause 7.2.1 with qᵤ = 0, q_{d} =
q_{new}, and l = 0
a same TA as the TA associated with q_new

If a UE is provided TCI-State_r17 indicating a unified TCI state, after X symbols from a
last symbol of a PDCCH reception with a DCI format scheduling a PUSCH transmission
with a same HARQ process number as for the transmission of the first PUSCH and having
a toggled NDI field value, the UE
monitors PDCCH in all CORESETs, and receives PDSCH and aperiodic CSI-RS in a
resource from a CSI-RS resource set using the same antenna port quasi co-location
parameters as the ones associated with the corresponding index q_{new}, if any
transmits PUCCH, PUSCH and SRS that uses a same spatial domain filter with same
indicated TCI state as for the PUCCH and PUSCH, using a same spatial domain filter as the
one corresponding to q_{new}, if any
transmits PUCCH, PUSCH and SRS [(maybe not needed) that uses a same spatial
domain filter with same indicated TCI state as for the PUCCH and PUSCH], using a same
TA as the one corresponding to q_{new}, if any

If a UE is provided TCI-State_r17 indicating a unified TCI state for the PCell or the PSCell
[6, TS 38.214], after X symbols from a last symbol of a first PDCCH reception in a search
space set provided by recoverySearchSpaceId where the UE detects a DCI format with
CRC scrambled by C-RNTI or MCS-C-RNTI, the UE
if AdditionalPCIInfo is not provided, monitors PDCCH in all CORESETs, and
receives PDSCH and aperiodic CSI-RS in a resource from a CSI-RS resource set with same
indicated TCI state as for the PDCCH and PDSCH, using the same antenna port quasi
co-location parameters as the ones associated with the corresponding index q_{new}, if any
transmits PUCCH, PUSCH and SRS that uses a same spatial domain filter with
same indicated TCI state as for the PUCCH and the PUSCH, using a same spatial
domain filter as for the last PRACH transmission
transmits PUCCH, PUSCH and SRS [(maybe not needed) that uses a same spatial
domain filter with same indicated TCI state as for the PUCCH and the PUSCH],
using a same TA as for the last PRACH transmission

Returning back to FIG. 2, if the terminal device 110 transmits a second uplink channel with one TA value to the first network device 120 and a third uplink channel with the other TA value to the second network device 130 in a Time-Divisional Multiplexing (TDM) mechanism respectively, the order of applying the first TA value and the second TA value should be considered. Further, the guard interval between the applying different TA values is also a key aspect.

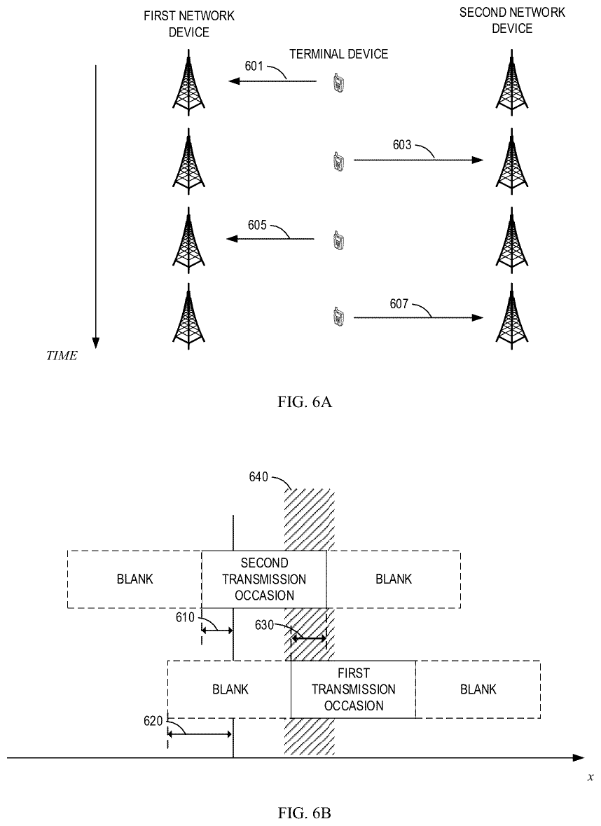

In some embodiments, the first set of RS resources associated with the first TA value is applied to a first transmission occasion of two consecutive transmission occasions, and the second set of RS resources associated with the second TA value is applied to a second transmission occasion of the two consecutive transmission occasions. The terminal device 110 further performs the second and third uplink channels with different TA values in the two consecutive transmission occasions based on an order mapping table. The order mapping table may indicate the order of applied TA values within the two consecutive transmission occasions. It is to be understood that the expression “first transmission occasion” and “second transmission occasion” in this disclosure are not intended to indicate the order of the transmission occasion within the two consecutive transmission occasions, but only used for distinguishing the transmission occasions. For discussion clarity, the mapping order of applied TA values and the guard interval in TDM transmission are discussed with reference to FIG. 6A and FIG. 6B.

FIG. 6A and FIG. 6B illustrate an example mapping order of TA values according to some embodiments of the present disclosure.

In FIG. 6A, the terminal device may be the terminal device 110 in FIG. 1, the first network device may be the first network device 120 in FIG. 1 and the second network device may be the second network device 130 in FIG. 1. In the example of FIG. 6A, the order of uplink transmissions to the network devices is illustrated by the reference numbers 601, 603, 605 and 607. It is to be understood that the number of uplink transmissions is shown only for illustrating without any limitation. In some embodiments, the order of TA values applied to the uplink transmissions may be indicated in a mapping order table. For example, the first TA value is applied to the first uplink transmission 601 and the second TA value is applied to the second uplink transmission 603. Then, the mapping order can be applied to following uplink transmissions repeatedly. It is to be understood that the periodicity of “two uplink transmissions” is only for discussing without any limitation.

As shown in FIG. 6B, in an example, the time length 610 represents the second TA value applied to the third uplink transmission, the time length 620 represents the first TA value applied to the second uplink transmission. Moreover, the second TA value is applied to the second transmission occasion. The first TA value is applied to the first transmission occasion. In some embodiments, the transmission occasion may comprise a slot.

In some embodiments, the order mapping table may comprise a bit field for indicating the mapping order of the applied TA values within the two consecutive transmission occasions. For example, the bit field may be {10}, and this bit field indicates that the first TA value is applied to the first one within the consecutive transmission occasions, and the second TA value is applied to the second one with in the consecutive transmission occasions. In addition or alternatively, the first TA value is associated with the first SRS resource set and the second TA value is associated with the second SRS resource set. In another example, the bit field may be {11}, and this bit field indicates that the first transmission occasion with the first TA value is positioned as the ending position of the two consecutive transmission occasions and the second transmission occasion with the second TA value is positioned as the starting position of the two consecutive transmission occasions (as shown in FIG. 6). In a yet example, the bit field may be {01}, the two transmission occasions are all the second transmission occasions with the second TA value. In a further example, the bit field may be {00}, the two transmission occasions are all the first transmission occasions with the first TA value. In addition, the first and the second SRS resource sets are respectively the ones with lower and higher srs-ResourceSetId of the two SRS resources sets.

In some embodiments, the above bit field may be indicated by the SRS resource set indicator in the DCI, for example, as shown in table 5.

TABLE 5

| SRS resource set | Mapping order of TA values on transmission |
|---|---|
| indicator | occasions |
| 00 | First TA value |
| 01 | Second TA value |
| 10 | First TA value, Second TA value |
| 11 | Second TA value, First TA value |

It is understood that the above association is shown as an example, and the association between the SRS resource set indicator and the mapping order of TA values for the time unis can be predefined arbitrarily.

As shown in FIG. 6B, since the first TA value is different from the second TA value, the first transmission occasion for the first network device 120 and the second transmission occasion for the second network device 130 may also overlap with each other. In this case, a guard interval 640 is required to avoid for the overlapping 630 between these transmission occasions. In some embodiments, the guard interval is larger than the |first TA value−second TA value|. In addition or alternatively, the guard interval may be determined based on more conditions, for example, UE panel switching time, beam switching time, Tx-Rx transition time, channel preparation time, signaling decoding time, and so on.

The guard interval 640 is reserved between transmission occasions of repetition-based transmissions, for example, PUSCH repetition, PUCCH repetition, PRACH repetition. In addition or alternatively, the guard interval is reserved between transmission occasions of multiple-occasion transmission, for example, multi-slot PUSCH transmission, slot aggregation, slot bundling, etc. Regarding PUSCH, it can be grant-based PUSCH and configured grant based PUSCH and it can refer to a nominal transmission or refer to an actual transmission.

The guard interval is counted between last symbol of UL transmissions applied with the first TA value and the first symbol of UL transmissions applied with the second TA value. Alternatively, it can be counted between last symbol of the slot of UL transmissions applied with the first TA value and the first symbol of the slot of UL transmissions applied with the second TA value. In addition or alternatively or, the overlapped or partial-overlapped transmission occasions is dropped.

In a more general cases, the guard interval is reserved between two transmission occasions of any UL channels/signals, for example, between two PUSCH transmissions scheduled by different DCI, between two PUSCH transmissions by UL grant and configured grant respectively, between two PUCCH transmissions carrying ACKs for different TRPs, between PUCCH and PUSCH, between two SRS resources, between two SRS resource sets, and so on.

In addition, if considering asynchronization network devices, the timing difference between the network devices needed to be included in the consideration of the length of the guard interval. For example, the guard interval is at least larger than |T_{TA,1}−T_{TA,2}|±sychronization timing difference to avoid any time-domain overlapping. Alternatively, T_{TA,1}−T_{TA,2}±Td, or max (0, T_{TA,1}−T_{TA,2}±Td).

Alternatively, the above TDM transmission configuration in MTRP communication may be also expressed as following.

When two SRS resource sets are configured in srs-ResourceSetToAddModList or
srs-ResourceSetToAddModListDCI-0-2 with higher layer parameter usage in
SRS-ResourceSet set to ‘codebook’ or ‘noncodebook’, for PUSCH repetition Type A, in case
K > 1, the same symbol allocation is applied across the K consecutive slots. The UE shall
repeat the TB across the K consecutive slots applying the same symbol allocation in each
slot, and the association of the first and second SRS resource in
set
srs-ResourceSetToAddModList or srs-ResourceSetToAddModListDCI-0-2 to each slot is
determined as follows:
<omitted>
if a DCI format 0_1 or DCI format 0_2 indicates codepoint “10” for the SRS
resource set indicator, the first and second SRS resource set association to K consecutive
slots is determined as follows:
When K = 2, the first and second SRS resource sets are applied to the first and
second slot of 2 consecutive slots, respectively. The first and second TA values are
applied respectively. The time gap between the last symbol of PUSCH in the first slot and
the first symbol of PUSCH in the second slot shall be larger than the difference between the
first and second TA values.
When K > 2 and cyclicMapping in PUSCH-Config is enabled, the first
and second SRS resource sets are applied to the first and second slot of K
consecutive slots, respectively, and the same SRS resource set mapping pattern
continues to the remaining slots of K consecutive slots. The first and second TA
values are applied respectively, and the same TA mapping pattern continues to the
remaining slots of K consecutive slots. The time gap between the last symbol of
PUSCH in the k-th slot and the first symbol of PUSCH in the (k + 1)-th slot shall be
larger than the difference between the first and second TA values.
<omitted>
Otherwise, a DCI format 0_1 or DCI format 0_2 indicates codepoint “11” for the
SRS resource set indicator, and the first and second SRS resource set association to K
consecutive slots is determined as follows,
When K = 2, the second and first SRS resource set are applied to the first and
second slot of 2 consecutive slots, respectively. The second and first TA values are applied
respectively. The time gap between the last symbol of PUSCH in the first slot and the first
symbol of PUSCH in the second slot shall be larger than the difference between the first
and second TA values.
When K > 2 and cyclicMapping in PUSCH-Config is enabled, the second
and first SRS resource sets are applied to the first and second slot of K consecutive
slots, respectively, and the same SRS resource set mapping pattern continues to the
remaining slots of the K consecutive slots. The second and first TA values are
applied respectively, and the same TA mapping pattern continues to the remaining
slots of K consecutive slots. The time gap between the last symbol of PUSCH in
the k-th slot and the first symbol of PUSCH in the (k + 1)-th slot shall be larger than
the difference between the first and second TA values.
<omitted>
For PUSCH repetition Type B, when two SRS resource sets are configured in
srs-ResourceSetToAddModList or srs-ResourceSetToAddModListDCI-0-2 with higher layer
parameter usage in SRS-ResourceSet set to ‘codebook’ or ‘noncodebook’, the SRS resource
set association to nominal PUSCH repetitions follows the same method as SRS resource set
association to slots in PUSCH Type A repetition by considering nominal repetitions instead
of slots.

In this way, the terminal device may reuse existing indicator for determining the mapping order between the TA values and the transmission occasions and further avoid the overlapping between transmission occasions.

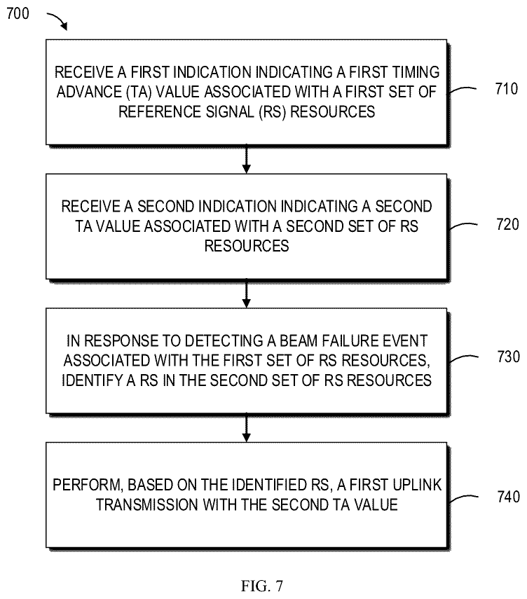

FIG. 7 illustrates a flowchart of a method 700 of communication implemented at a terminal device in accordance with some embodiments of the present disclosure. The method 700 can be implemented at the terminal device 110 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At block 710, the terminal device 110 receives a first indication indicating a first timing advance (TA) value associated with a first set of Reference Signal (RS) resources.

At block 720, the terminal device 110 receives a second indication indicating a second TA value associated with a second set of RS resources.

At block 730, the terminal device 110 identifies a recovery beam corresponding to a second RS resource in the second set of RS resources in response to detecting a beam failure event associated with the first set of RS resources.

At block 740, the terminal device 110 performs a first uplink transmission with the second TA value.

In some embodiments, receiving the first indication and the second indication comprises: receiving a first configuration for the first set of RS resources having the first TA value and a second configuration for the second set of RS resources having the second TA value respectively.

In some embodiments, receiving the first indication and the second indication comprises: receiving at least one first parameter indicating a TA value and at least one second parameter indicating a TA offset value.

In some embodiments, the method further comprises in response to transmitting a Physical Random Access Channel (PRACH) with a third TA value, adjusting at least one of the first TA value and the second TA value by the third TA value.

In some embodiments, the method further comprises in response to detecting that there is a first timing difference value between a first downlink channel transmission from a first network device and a second downlink channel transmission from a second network device, adjusting at least one of the first TA value and the second TA value by the first timing difference value.

In some embodiments, a second timing difference value between the first TA value and the second TA value is smaller than a first threshold: and/or wherein the second timing difference value between the first TA value and the second TA value is larger than a second threshold.

In some embodiments, the method further comprises in response to a beam switching procedure being performed, enabling at least one of the first TA value and the second TA value based on ending time of the beam switching procedure: and/or in response to a power control procedure being performed, enabling at least one of the first TA value and the second TA value based on ending time of the power control procedure.

In some embodiments, the first TA value is configured with a first timer and the second TA value is configured with a different second timer: or the first TA value and the second TA value are configured with a third timer.

In some embodiments, at least one of the first timer, the second timer and the third timer is started or restarted at least based on receiving an indication indicating a corresponding TA value, and wherein the at least one timer is determined as expired based on at least one of: running time of the at least one timer reaches corresponding expiration time: a first maximum uplink transmission timing difference between a plurality of TA values is exceeded, each of the plurality of TA values being associated with a respective network device: a second maximum uplink transmission timing difference between a plurality of network devices is exceeded, each of the plurality of network devices being associated with a respective TA group of a Medium Access Control (MAC) entity: and a third maximum uplink transmission timing difference between a plurality of network devices is exceeded, each of the plurality of network devices being associated with a respective TA group of a Medium Access Control (MAC) entity of the terminal device.

In some embodiments, the method further comprises: transmitting a Beam Failure Recovery Request (BFRQ) with the second TA value: transmitting a BFRQ with a default TA value: and transmitting a BFRQ with a third value associated with a uplink channel resource for the BFRQ.

In some embodiments, the method further comprises: performing a uplink transmission with an updated TA value, wherein the updated TA value is received in a BFRQ response in response to the transmitted BFRQ or is received in a fourth indication indicating the updated TA value in response to the transmitted BFRQ.

In some embodiments, the method further comprises: the default TA value is determined from at least one of: zero, the first TA value, the second TA value, and a TA value applied to a latest successful uplink transmission.

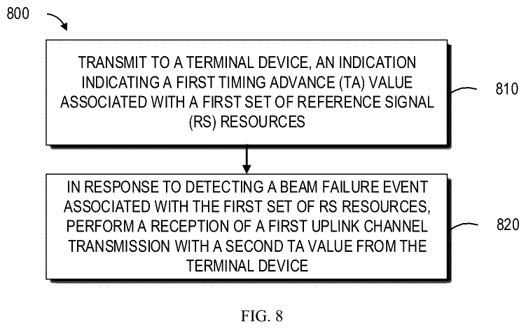

FIG. 8 illustrates a flowchart of a method 800 of communication implemented at a terminal device in accordance with some embodiments of the present disclosure. The method 800 can be implemented at the first network device 120 or the second network device 130 shown in FIG. 1. For the purpose of discussion, the method 800 will be described with reference to FIG. 1. It is to be understood that the method 800 may include additional acts not shown and/or may omit some shown acts, and the scope of the present disclosure is not limited in this regard.

At block 810, the network device 120 or 130 transmits, to a terminal device, an indication indicating a first timing advance (TA) value associated with a first set of Reference Signal (RS) resources.

At block 820, the network device 120 or 130 performs a reception of a first uplink transmission with a second TA value from the terminal device in response to detecting a beam failure event associated with the first set of RS resources.

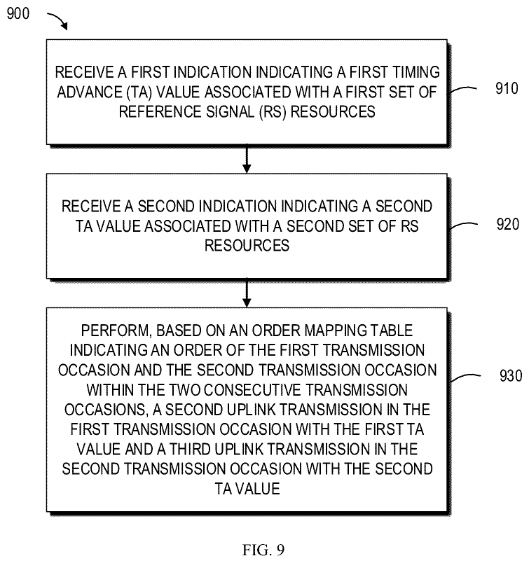

FIG. 9 illustrates a flowchart of a method 900 of communication implemented at a terminal device in accordance with some embodiments of the present disclosure. The method 900 can be implemented at the terminal device 110 shown in FIG. 1. For the purpose of discussion, the method 900 will be described with reference to FIG. 1. It is to be understood that the method 900 may include additional acts not shown and/or may omit some shown acts, and the scope of the present disclosure is not limited in this regard.

At block 910, the terminal device 110 receives a first indication indicating a first timing advance (TA) value associated with a first set of Reference Signal (RS) resources. The first set of RS resources is applied to a first transmission occasion of two consecutive transmission occasions.

At block 920, the terminal device 110 receives a second indication indicating a second TA value associated with a second set of RS resources. The second set of RS resources is applied to a second transmission occasion of the two consecutive transmission occasions.

At block 930, the terminal device 110 performs, based on an order mapping table indicating an order of the first transmission occasion and the second transmission occasion within the two consecutive transmission occasions, a second uplink transmission in the first transmission occasion with the first TA value and a third uplink transmission in the second transmission occasion with the second TA value.

In some embodiments, receiving the first indication and the second indication comprises: receiving a first configuration for the first set of RS resources having the first TA value and a second configuration for the second set of RS resources having the second TA value respectively.

In some embodiments, receiving the first indication and the second indication comprises: receiving at least one first parameter indicating a TA value and at least one second parameter indicating a TA offset value.

In some embodiments, the method further comprises in response to transmitting a Physical Random Access Channel (PRACH) with a third TA value, adjusting at least one of the first TA value and the second TA value by the third TA value.

In some embodiments, the method further comprises in response to detecting that there is a first timing difference value between a first downlink channel transmission from a first network device and a second downlink channel transmission from a second network device, adjusting at least one of the first TA value and the second TA value by the first timing difference value.

In some embodiments, a second timing difference value between the first TA value and the second TA value is smaller than a first threshold; and/or wherein the second timing difference value between the first TA value and the second TA value is larger than a second threshold.

In some embodiments, the method further comprises in response to a beam switching procedure being performed, enabling at least one of the first TA value and the second TA value based on ending time of the beam switching procedure: and/or in response to a power control procedure being performed, enabling at least one of the first TA value and the second TA value based on ending time of the power control procedure.

In some embodiments, the first TA value is configured with a first timer and the second TA value is configured with a different second timer: or the first TA value and the second TA value are configured with a third timer.

In some embodiments, at least one of the first timer, the second timer and the third timer is started or restarted at least based on receiving an indication indicating a corresponding TA value, and wherein the at least one timer is determined as expired based on at least one of: running time of the at least one timer reaches corresponding expiration time: a first maximum uplink transmission timing difference between a plurality of TA values is exceeded, each of the plurality of TA values being associated with a respective network device: a second maximum uplink transmission timing difference between a plurality of network devices is exceeded, each of the plurality of network devices being associated with a respective TA group of a Medium Access Control (MAC) entity: and a third maximum uplink transmission timing difference between a plurality of network devices is exceeded, each of the plurality of network devices being associated with a respective TA group of a Medium Access Control (MAC) entity of the terminal device.

In some embodiments, the order indicated by the mapping order table corresponds to a Sounding Reference Signal (SRS) indicator.

In some embodiments, the method further comprises, the terminal device 110 performs, based on a guard interval between the first transmission occasion and the second transmission occasion, the second uplink transmission in the first transmission occasion and the third uplink transmission in the second transmission occasion.

In some embodiments, the guard interval is larger than a second timing difference value between the first TA value and the second TA value.

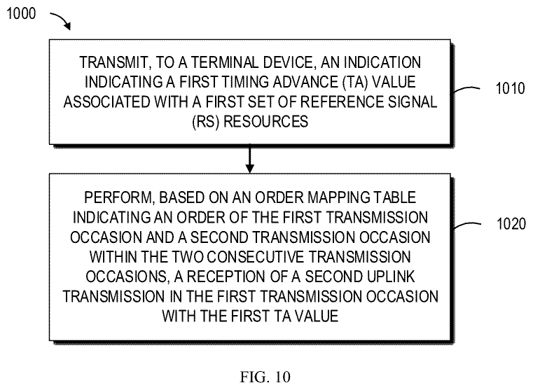

FIG. 10 illustrates a flowchart of a method 1000 of communication implemented at a network device in accordance with some embodiments of the present disclosure. The method 1000 can be implemented at the first network device 120 or the second network device 130 shown in FIG. 1. For the purpose of discussion, the method 1000 will be described with reference to FIG. 1. It is to be understood that the method 1000 may include additional acts not shown and/or may omit some shown acts, and the scope of the present disclosure is not limited in this regard.

At block 1010, the network device 120 or 130 transmits, to a terminal device, an indication indicating a first timing advance (TA) value associated with a first set of Reference Signal (RS) resources. The first set of RS resources is applied to a first transmission occasion of two consecutive transmission occasions.

At block 1020, the network device 120 or 130 performs, based on an order mapping table indicating an order of the first transmission occasion and a second transmission occasion within the two consecutive transmission occasions, a reception of a second uplink in the first transmission occasion with the first TA value.

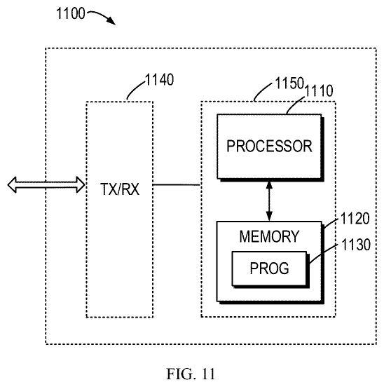

FIG. 11 is a simplified block diagram of a device 1100 that is suitable for implementing some embodiments of the present disclosure. The device 1100 can be considered as a further example embodiment of the terminal device 110 as shown in FIG. 1. or network devices 120 and 130 as shown in FIG. 1. Accordingly, the device 1100 can be implemented at or as at least a part of the above network devices or terminal devices.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to FIGS. 1-10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a terminal device comprises circuitry configured to perform method 700 or 900.

In some embodiments, a network device comprises circuitry configured to perform method 800 or 1000.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

According to first aspect of this disclosure, a method implemented at a terminal device is provided. In this method, the terminal device receives a first indication indicating a first timing advance (TA) value associated with a first set of Reference Signal (RS) resources. The terminal device receives a second indication indicating a second TA value associated with a second set of RS resources. In response to detecting a beam failure event associated with the first set of RS resources, the terminal device identifies a RS in the second set of RS resources and performs, based on the identified RS, a first uplink transmission with the second TA value.

In some embodiments, receiving the first indication and the second indication comprises: receiving a first configuration for the first set of RS resources having the first TA value and a second configuration for the second set of RS resources having the second TA value respectively.

In some embodiments, receiving the first indication and the second indication comprises: receiving at least one first parameter indicating a TA value and at least one second parameter indicating a TA offset value.

In some embodiments, the method further comprises in response to transmitting a Physical Random Access Channel (PRACH) with a third TA value, adjusting at least one of the first TA value and the second TA value by the third TA value.

In some embodiments, the method further comprises in response to detecting that there is a first timing difference value between a first downlink channel transmission from a first network device and a second downlink channel transmission from a second network device, adjusting at least one of the first TA value and the second TA value by the first timing difference value.

In some embodiments, a second timing difference value between the first TA value and the second TA value is smaller than a first threshold: and/or wherein the second timing difference value between the first TA value and the second TA value is larger than a second threshold.

In some embodiments, the method further comprises in response to a beam switching procedure being performed, enabling at least one of the first TA value and the second TA value based on ending time of the beam switching procedure: and/or in response to a power control procedure being performed, enabling at least one of the first TA value and the second TA value based on ending time of the power control procedure.

In some embodiments, the first TA value is configured with a first timer and the second TA value is configured with a different second timer: or the first TA value and the second TA value are configured with a third timer.

In some embodiments, at least one of the first timer, the second timer and the third timer is started or restarted at least based on receiving an indication indicating a corresponding TA value, and wherein the at least one timer is determined as expired based on at least one of: running time of the at least one timer reaches corresponding expiration time: a first maximum uplink transmission timing difference between a plurality of TA values is exceeded, each of the plurality of TA values being associated with a respective network device; a second maximum uplink transmission timing difference between a plurality of network devices is exceeded, each of the plurality of network devices being associated with a respective TA group of a Medium Access Control (MAC) entity: and a third maximum uplink transmission timing difference between a plurality of network devices is exceeded, each of the plurality of network devices being associated with a respective TA group of a Medium Access Control (MAC) entity of the terminal device.

In some embodiments, the method further comprises: transmitting a Beam Failure Recovery Request (BFRQ) with the second TA value: transmitting a BFRQ with a default TA value; and transmitting a BFRQ with a third value associated with a uplink channel resource for the BFRQ.

In some embodiments, the method further comprises: in response to the transmitted BFRQ, receiving a fourth indication indicating a fourth TA value: and performing a uplink transmission with the fourth TA value.

In some embodiments, the method further comprises: in response to the transmitted BFRQ, receiving a BFRQ response comprising a third TA value; and performing a uplink transmission with the third TA value.

In some embodiments, the method further comprises: the default TA value is determined from at least one of: zero, the first TA value, the second TA value, and a TA value applied to a latest successful uplink transmission.

According to second aspect of this disclosure, there is provided a computer readable medium having instructions stored thereon, the instructions, when executed on at least one processor, causing the at least one processor to perform any of the methods 700-1000.

1-20. (canceled)

21. A method performed by a user equipment comprising:
receiving first information and second information,
wherein the first information indicates a first offset,
wherein the first offset is used to calculate a first timing advance (TA), and is associated with a first set of reference signal (RS) resources,
wherein the second information indicates a second offset,
wherein the second offset is used to calculate a second TA, and is associated with a second set of RS resources,
wherein the first set of RS resources is applied to a first transmission occasion of two consecutive transmission occasions, and
wherein the second set of RS resources is applied to a second transmission occasion of the two consecutive transmission occasions; and
performing, based on information indicating that the first offset is applied to the first transmission occasion and the second offset is applied to the second transmission occasion, a first uplink transmission in the first transmission occasion by using the first offset and a second uplink transmission in the second transmission occasion by using the second offset.

22. The method according to claim 21,
wherein the first offset is associated with a first physical cell identity, and
wherein the first offset is associated with a second physical cell identity.

23. The method according to claim 21,
wherein the first uplink transmission and the second uplink transmission do not overlap.

24. The method according to claim 21,
wherein the first uplink transmission and the second uplink transmission do not overlap due to reducing in duration the second uplink transmission.

25. The method according to claim 21,
wherein the first offset is configured with a first timer and the second offset is configured with a second timer or the first offset and the second offset are configured with a third timer,
wherein at least one of the first timer, the second timer and the third timer is started or restarted at least based on receiving an indication, and
wherein the at least one of the first timer, the second timer and the third timer is determined as expired in a case where a maximum uplink transmission timing difference related to TA groups of a Medium Access Control (MAC) entity of the user equipment is exceeded.

26. The method according to claim 25, further comprising:
clearing a configured downlink assignment, a configured uplink grant and a Physical Uplink Shared Channel (PUSCH) resource for semi-persistent Channel State Information (CSI) reporting in a case where the at least one of the first timer, the second timer and the third timer is determined as expired.

27. The method according to claim 21, further comprising:
sending information indicating that the user equipment supports the first TA and the second TA.

28. The method according to claim 21, further comprising:
sending information indicating that the user equipment supports the first TA and the second TA for two panels.

29. A method performed by a network device comprising:
sending first information and second information to a user equipment,
wherein the first information indicates a first offset,
wherein the first offset is used to calculate a first timing advance (TA), and is associated with a first set of reference signal (RS) resources,
wherein the second information indicates a second offset,
wherein the second offset is used to calculate a second TA, and is associated with a second set of RS resources,
wherein the first set of RS resources is applied to a first transmission occasion of two consecutive transmission occasions, and
wherein the second set of RS resources is applied to a second transmission occasion of the two consecutive transmission occasions; and
performing, based on information indicating that the first offset is applied to the first transmission occasion and the second offset is applied to the second transmission occasion, a first uplink reception in the first transmission occasion by using the first offset and a second uplink reception in the second transmission occasion by using the second offset.

30. The method according to claim 29,
wherein the first offset is associated with a first physical cell identity, and
wherein the first offset is associated with a second physical cell identity.

31. The method according to claim 29,
wherein the first uplink reception and the second uplink reception do not overlap.

32. The method according to claim 29,
wherein the first uplink reception and the second uplink reception do not overlap due to reducing in duration a transmission corresponding to the second uplink reception.

33. The method according to claim 29,
wherein the first offset is configured with a first timer and the second offset is configured with a second timer or the first offset and the second offset are configured with a third timer,
wherein at least one of the first timer, the second timer and the third timer is started or restarted at least based on an indication, and
wherein the at least one of the first timer, the second timer and the third timer is determined as expired in a case where a maximum uplink transmission timing difference related to TA groups of a Medium Access Control (MAC) entity of the user equipment is exceeded.

34. The method according to claim 33,
a configured downlink assignment, a configured uplink grant and a Physical Uplink Shared Channel (PUSCH) resource for semi-persistent Channel State Information (CSI) reporting are cleared in a case where the at least one of the first timer, the second timer and the third timer is determined as expired.

35. The method according to claim 29, further comprising:
receiving information indicating that the user equipment supports the first TA and the second TA.

36. The method according to claim 29, further comprising:
receiving information indicating that the user equipment supports the first TA and the second TA for two panels.

37. A user equipment comprising:
at least one memory; and
at least one hardware processor coupled to the at least one memory,
wherein the at least one hardware processor is configured to:
receive first information and second information,
wherein the first information indicates a first offset,
wherein the first offset is used to calculate a first timing advance (TA), and is associated with a first set of reference signal (RS) resources,
wherein the second information indicates a second offset,
wherein the second offset is used to calculate a second TA, and is associated with a second set of RS resources,
wherein the first set of RS resources is applied to a first transmission occasion of two consecutive transmission occasions, and
wherein the second set of RS resources is applied to a second transmission occasion of the two consecutive transmission occasions; and
perform, based on information indicating that the first offset is applied to the first transmission occasion and the second offset is applied to the second transmission occasion, a first uplink transmission in the first transmission occasion by using the first offset and a second uplink transmission in the second transmission occasion by using the second offset.

38. A network device comprising:
at least one memory; and
at least one hardware processor coupled to the at least one memory,
wherein the at least one hardware processor is configured to:
send first information and second information to a user equipment,
wherein the first information indicates a first offset,
wherein the first offset is used to calculate a first timing advance (TA), and is associated with a first set of reference signal (RS) resources,
wherein the second information indicates a second offset,
wherein the second offset is used to calculate a second TA, and is associated with a second set of RS resources,
wherein the first set of RS resources is applied to a first transmission occasion of two consecutive transmission occasions, and
wherein the second set of RS resources is applied to a second transmission occasion of the two consecutive transmission occasions; and
perform, based on information indicating that the first offset is applied to the first transmission occasion and the second offset is applied to the second transmission occasion, a first uplink reception in the first transmission occasion by using the first offset and a second uplink reception in the second transmission occasion by using the second offset.
